(19) United States
(12) Patent Application Publication
(10) Pub. No.: US 2025/0378175 A1
(43) Pub. Date: Dec. 11, 2025

(54) TECHNIQUES FOR DETERMINING CORRECTNESS AND/OR FOR GENERATING AN ASSESSMENT OF THE RISK OF CYBER ATTACKS ON A SYSTEM

(71) Applicant: Robert Bosch GmbH, Stuttgart (DE)

(72) Inventors: Christopher Huth, Heilbronn (DE); Dominik Germek, Berlin (DE); Martin Ring, Lossburg (DE); Max Camillo Eisele, Ludwigsburg (DE); Niclas Ilg, Ammerbuch (DE)

(21) Appl. No.: 19/202,292

(22) Filed: May 8, 2025

(30) Foreign Application Priority Data
Jun. 7, 2024 (DE) 10 2024 205 232.9

(51) Int. Cl. G06F 21/57

(52) U.S. Cl. CPC G06F 21/577; G06F 2221/034

(57) ABSTRACT

A method for determining correctness and/or for generating an assessment of the risk of cyber attacks on a particular system. The method includes receiving a request to carry out cyber attack(s) on the system and invoking a machine learning agent. The machine learning agent accesses a generative machine learning model. The method further includes carrying out one or more cyber attacks on the system using the machine learning agent in response to the request, evaluating the results of the one or more carried out cyber attacks and determining, based on a finding of the step of evaluating the result, whether a predetermined assessment of the risk of cyber attacks on the particular system is correct or generating, based on a finding of the step of evaluating the result, an assessment of the risk of cyber attacks on the particular system.

### CROSS REFERENCE

The present application claims the benefit under 35 U.S.C. § 119 of German Patent Application No. DE 10 2024 205 232.9 filed on Jun. 7, 2024, which is expressly incorporated herein by reference in its entirety.

### BACKGROUND INFORMATION

In many areas of technology, it is desirable or even required to carry out an assessment of the risk of cyber attacks on the system within the framework of product development. For this purpose, formalized metrics for threat and risk analysis are sometimes used. In the automotive sector, for example, a metric for threat and risk analysis is defined in the ISO/SAE 21434 standard. Within the framework of the threat and risk analysis, various cyber attacks on the system are simulated. The initial assessment of the threat and risk situation may need to be adjusted and refined during the further product life cycle.

Some traditional approaches to creating an assessment of the risk of cyber attacks on a system involve test engineers to a significant extent (so much so that they could even be described as “manual”). For example, a test engineer can simulate various cyber attack scenarios in a test environment. Additionally or alternatively, a test engineer can assess the risk of cyber attacks based on at least partially subjective criteria. In some cases, part of the assessment can include a classification of how sophisticated or complex a cyber attack on a system must be to be successful. This assessment is therefore subject to errors of human judgment (e.g., distortions/biases or random assessment errors).

As a result, some of the techniques for the assessment of the risk of cyber attacks of the prior art can be highly time-consuming. In addition, the assessments may be subject to human error.

The present invention provides certain solutions that can address these problems.

### SUMMARY

A method according to the first aspect according to the present invention proposed in this disclosure relates to a method for determining correctness and/or for generating an assessment of the risk of cyber attacks on a particular system. According to an example embodiment of the present invention, the method comprises receiving a request to carry out one or more cyber attacks on the particular system and invoking a machine learning agent. The machine learning agent is designed to access a generative machine learning model that is trained to generate data sets and, based on a request, generate and carry out one or more cyber attacks on a system using the generative machine learning model. The method further comprises carrying out one or more cyber attacks on the system using the machine learning agent in response to the request, evaluating the results of the one or more carried out cyber attacks and determining, based on a finding of the step of evaluating the result, whether a predetermined assessment of the risk of cyber attacks on the particular system is correct or generating, based on a finding of the step of evaluating the result, an assessment of the risk of cyber attacks on the particular system.

The method according to the present invention proposed in this disclosure according to a second aspect is a method for training and/or configuring a machine learning agent to determine correctness and/or to generate an assessment of the risk of cyber attacks on a particular system. According to an example embodiment of the present invention, the method comprises receiving a generative machine learning model that is trained to generate data sets. The method further comprises configuring a machine learning agent to access the generative machine learning model that is trained to generate data sets and to generate and carry out one or more cyber attacks on a system based on a request using the generative machine learning model.

According to a third aspect of the present invention, an environment is provided that is designed to carry out one of the methods according to the first and/or second aspects. The environment can be a test and/or development environment for a particular system.

The present invention comprises, according to a fourth aspect, a computer program that contains instructions that, when executed by a computing unit, cause the computing unit to carry out a method for determining correctness and/or for generating a metric assessment of the risk of cyber attacks on a particular system according to the present invention.

The present invention comprises, according to a fifth aspect, a computer-readable medium or signal that stores and/or contains the computer program according to the fourth aspect of the present invention.

The techniques of the first to fifth aspects can comprise one or more of the following advantages in some implementations.

First, the methods of the present invention can reduce the time and/or resources required to determine correctness and/or generate an assessment of the risk of cyber attacks on a particular system. In some examples, the determination or generation can even be carried out on a completely automated basis (i.e., without interaction with a human test engineer). Many methods of the prior art contain significant non-automated components (one might even describe these methods as “pen-and-paper” or “manual,” even though they involve the use of computer tools). The machine learning agent of the present disclosure can, in some examples, be capable of generating and carrying out cyber attacks on the system (e.g., using a model of the system), evaluating the results of these cyber attacks (e.g., whether and, if so, which vulnerabilities were found), and accordingly reviewing or generating an assessment (e.g., according to a predetermined metric) of the risk of cyber attacks on the particular system. In extreme cases, this can reduce the time required to carry out the method from many hours or even days to just a few minutes. Even partial automation of the above-mentioned tasks can result in a (possibly significant) time saving compared to some methods of the prior art.

Second, by means of the methods of the present invention, the influence of human assessment errors on the assessment of the risk of cyber attacks on the system can be reduced. In some methods of the related art, it is the responsibility of a human tester to assess the risk of cyber attacks according to a predetermined metric after carrying out more or less formalized tests (e.g., executing cyber attacks on the system). For example, a scale can be used to assess how sophisticated a cyber attack on a system must be to be successful or how complex the means required are (e.g., access to particular interfaces of the system). These assessments are subject to all known (and unknown) errors of human judgment. It is possible that different testers have different biases (and, e.g., estimate the same scenario higher or lower on the scale). The automation of the method according to the present disclosure can reduce this influence of human assessment errors in some situations (since the machine learning agent can carry out some or even all steps of the method without human intervention). It is also possible to test a large number of systems with the same machine learning agent, which can also contribute to greater comparability of the individual results.

Third, the use of a machine learning agent according to the present invention can increase the coverage of possible cyber attacks in the assessment in some examples. The machine learning agents can be equipped with knowledge of many or all known cyber attacks and can potentially carry out and evaluate them automatedly (as described above). In some cases, this can also lead to a more reliable assessment, since the risk of omitting relevant cyber attacks in the assessment can be reduced. In the process, the security of the systems being assessed can also be increased, since vulnerabilities can be found more reliably.

Fourth, in some examples, vulnerabilities in the system that are discovered within the framework of carrying out the cyber attacks can be at least partially remedied automatedly.

Some terms used in this disclosure are explained below.

A “cyber attack” (sometimes abbreviated to “attack” below) can be any attempt to obtain, disclose, modify, disable or destroy data, characteristics or other elements of a system by accessing the system (wherein the attempt may or may not be at least partially successful). A cyber attack can be an unauthorized attempt with the aforementioned goals. A cyber attack can use any means to achieve the above-mentioned goals. In some examples, a cyber attack targets a computing unit and/or peripheral components of a computing unit (e.g., interfaces or memory). Cyber attacks can be directed against systems that are designed for or contribute to electronic data processing in any form.

A “machine learning agent” is a system that is trained to use a machine learning model (e.g., a generative machine learning model, in particular a large language model (LLM)) to find a solution to a problem according to a particular plan (in the present disclosure, generating and carrying out cyber attacks and optionally the further steps of evaluating a result and determining correctness and/or of generating an assessment of the risk of cyber attacks on a particular system). For this purpose, the machine learning agent can be equipped with additional modules in addition to a generative machine learning model (e.g., a planning module, a storage module and/or tools for solving the problem). The further modules (e.g., the tools) can comprise machine learning models, but do not have to. By means of integrating them into a machine learning agent, generative machine learning models can be used to solve problems that may not be satisfactorily solvable by means of the generative machine learning model alone. For example, in many cases, a generative machine learning model in the form of a large language model cannot provide a satisfactory answer in response to a request (prompt) for solving a problem. A simple illustrative example is arithmetic problems. A generative machine learning model in the form of a large language model will provide an answer to a computational task posed to it as a request. However, in many cases this answer may not be mathematically correct, since it is generated with the aid of the general language generation mechanisms of the generative machine learning model. At this point, a machine learning agent can access a conventional computing program, e.g., by converting a computing task in a prompt into a request to an API of a computing program. The (correct) return value of the calculation program can then be embedded in the text generated by the generative machine learning model in the form of a large language model. Specific examples and possible configurations of machine learning agents for determining correctness and/or for generating a metric assessment of the risk of cyber attacks on a particular system according to the present disclosure are described below.

A “system” of the present disclosure may be any technical device designed to solve a specific technical problem. A system can comprise software and/or hardware components (or consist of one or more of these components). A system can comprise a computing unit or be designed to be executed on a computing unit. A system contains at least one component that can be the target of a cyber attack. For example, a system can be a computing unit (e.g., a control unit). Further specific examples are given below.

### BRIEF DESCRIPTION OF THE DRAWINGS

FIG. 1 schematically illustrates in the middle column a method for determining correctness and/or for generating an assessment of the risk of cyber attacks on a particular system according to an example embodiment of the present invention. FIG. 1 schematically illustrates in the left column a method for training and/or configuring a machine learning agent for determining correctness and/or for generating an assessment of the risk of cyber attacks on a particular system. FIG. 1 schematically illustrates in the right column methods for applying a system examined by means of the methods for determining correctness and/or for generating a metric assessment of the risk of cyber attacks.

FIG. 2 schematically illustrates a structure of a machine learning agent according to an example embodiment of the present disclosure.

FIG. 3 schematically illustrates a test and/or development environment in which the machine learning agent according to the present invention can be used.

### DETAILED DESCRIPTION OF EXAMPLE EMBODIMENTS

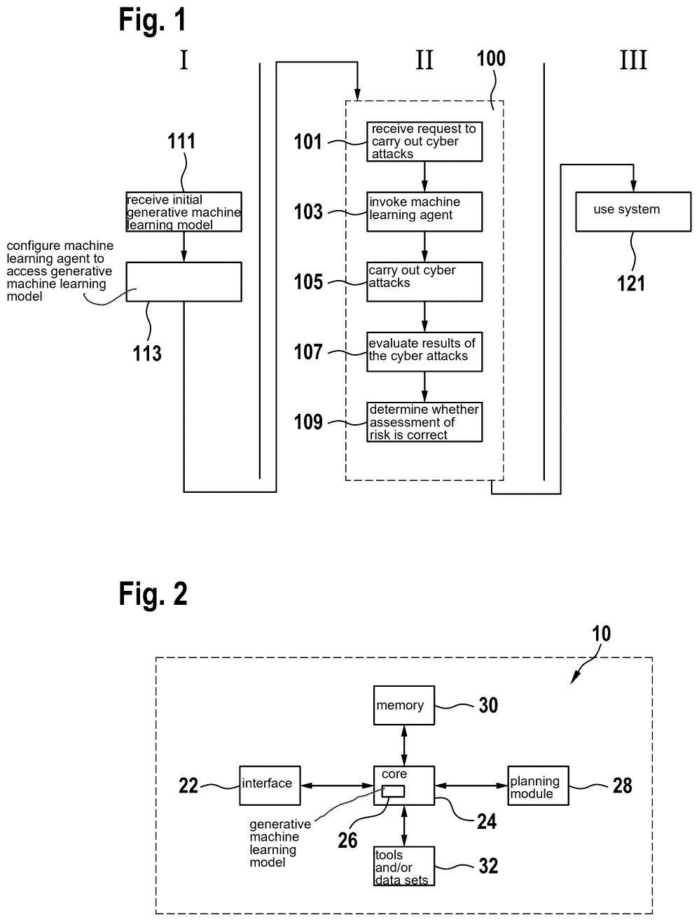

FIG. 1 schematically illustrates in the middle column (II) a method for determining correctness and/or for generating an assessment of the risk of cyber attacks on a particular system according to the present disclosure.

The method comprises receiving 101 a request to carry out one or more cyber attacks on the particular system. The request can be generated via a user interface. Additionally or alternatively, the request can be generated by an upstream computer system and transmitted to the environment carrying out the method for determining correctness and/or for generating a metric assessment of the risk of cyber attacks on a particular system according to the present disclosure. The request can specify the extent to which cyber attacks are to be carried out or the type of cyber attacks to be carried out. In other examples, the request can (e.g., only) contain the information that a method for determining correctness and/or for generating an assessment of the risk of cyber attacks on a particular system should be started. The request can also or alternatively comprise information or a description of the particular system and/or its context (environment). In some examples, the request can comprise a model (e.g., a simulation model) of the particular system and/or its context (environment).

The method further comprises invoking 103 a machine learning agent 10, wherein the machine learning agent is designed to access a generative machine learning model that is trained to generate data sets and to generate and carry out one or more cyber attacks on a system based on a request using the generative machine learning model.

In some examples, the generative machine learning model can comprise a generative foundation model. In some examples, the generative machine learning model can comprise a language generation model. For example, the generative machine learning model can comprise a large language model.

The machine learning model can be based on an existing (trained) generative machine learning model and adjusted (e.g., by further training and/or fine-tuning) with one or more of the techniques described below for use in the methods of the present disclosure. For example, the existing generative machine learning model can comprise one or more of CodeLlama, Llama, Mistral 7B, Ollama, CoPilot and/or language models from the GPT family (for example, ChatGPT). In other examples, multimodal models such as Gemini, GPT4o can be used. In other examples, the generative machine learning model can be designed and trained from the ground up for use in the techniques of the present disclosure (further details on adjusting and training will be presented below).

The data sets generated by the generative machine learning model can comprise text data. Alternatively or additionally, the data sets generated by the generative machine learning model can comprise image data (e.g., single images or video data). In some examples, the data sets generated by the generative machine learning model can comprise program code, calls to commands in a programming language, and/or database queries. Additionally or alternatively, carrying out one or more cyber attacks on the system can comprise executing program code, calling commands in a programming language and/or database queries.

Generating cyber attacks can take place in many different ways. In some examples, a path (an attack vector) for a possible cyber attack can initially be identified by the generative machine learning model. For example, the machine learning agent can request the generative machine learning model to identify a possible path for a cyber attack on the particular system (e.g., taking into account the characteristics and/or context of the particular system). For example, a possible path can be access via one of the interfaces of the particular system or access to another component of the particular system. In a further step, generating the attacks can comprise designing a strategy on how to attack the particular system along the identified path. This strategy can comprise one or more types of cyber attacks and/or targets of cyber attacks. In the example of access via one of the interfaces of the particular system, the strategy can comprise feeding one or more messages via the interface (for example, by means of carrying out fuzzing of the interface) with the aim of modifying a memory content of a memory of the particular system.

In some examples, generating the attack can comprise generating executable code, commands or requests to a tool or interface, with the aid of which the cyber attack (or parts thereof) can be carried out. For example, the interface can be an interface of a simulation environment or other test environment. For example, data streams in or into the system can be modified, the contents of memories in the system can be modified, or the context (environment) of the system can be modified.

Additionally or alternatively, in some examples, generating the attack can comprise generating executable code, commands or requests to a tool or interface with the aid of which effects of a cyber attack on a system can be monitored and/or registered. In one example, it can be monitored or recorded whether data, characteristics or other elements of a system have been obtained, disclosed, modified, disabled or destroyed by accessing the system. For example, data streams into or out of the system can be monitored, the contents of memories in the system can be monitored, or modifications in the behavior or characteristics of the system can be monitored. Possible implementations of the steps of generating the attacks (or monitoring their results) described above are discussed in connection with FIG. 2.

The method further comprises carrying out 105 one or more cyber attacks on the system using the machine learning agent in response to the request.

In some examples, the cyber attacks are carried out on a prototype of the particular system. Additionally or alternatively, the cyber attacks can be carried out on a model of the particular system. The model can be a simulation model of the particular system (i.e., the attacks can also be carried out simulatively, e.g., by interfering with a simulation environment). Additionally or alternatively, the particular system can at least partially comprise hardware components of the system under test on which cyber attacks are carried out (i.e., the attacks can be carried out at least partially in a test bench). In some examples, the cyber attacks can be carried out in a software-in-the-loop environment or in a hardware-in-the-loop environment.

In some examples, this can comprise carrying out all types of cyber attacks known to the machine learning agent. In other examples, the quantity and/or type of cyber attacks carried out may be limited according to particular criteria.

Carrying out 105 one or more cyber attacks can be iterative and/or can be carried out in a plurality of stages. A configuration of the machine learning agent can be selected differently in the different runs or stages (e.g., a configuration of the same machine learning agent can be modified or a plurality of differently configured machine learning agents can be used in the different runs or stages). For example, the machine learning agent can have different tools or data sets at different stages. Alternatively or additionally, the generative machine learning model can be trained and/or configured differently for different runs or stages (e.g., further training or fine-tuning for the differently trained and/or configured machine learning models can be carried out using different resources, e.g., databases with descriptions of known cyber attacks). Further additionally or alternatively, the machine learning agent can formulate different requests to the machine learning model for different runs or stages of the attacks (e.g., requesting that certain skills and knowledge not be considered for the attack).

The method further comprises evaluating 107 the results of the one or more cyber attacks carried out. The evaluation can comprise ascertaining whether a cyber attack was successful (e.g., whether data, characteristics or other elements of the system were obtained, disclosed, modified, disabled or destroyed by accessing the system within the framework of the cyber attack). Additionally or alternatively, the evaluation can comprise ascertaining whether a cyber attack was unsuccessful (e.g., whether data, characteristics or other elements of the system were not obtained, disclosed, modified, disabled and/or destroyed by accessing the system within the framework of the cyber attack). Further additionally or alternatively, the evaluation can comprise ascertaining whether, as a result of the cyber attack, particular characteristics or functionalities of the system are no longer available or no longer available in a desired quality.

The method further comprises determining 109, based on a finding of the step of evaluating the result, whether a predetermined assessment of the risk of cyber attacks on the particular system is correct. Alternatively or additionally, the method further comprises generating 109, based on a finding of the step of evaluating the result, an assessment of the risk of cyber attacks on the particular system.

In some examples, the machine learning agent is further designed to carry out the evaluation of a result. Additionally or alternatively, the machine learning agent can be further designed to determine and/or generate the assessment. In these examples, the evaluation of a result, the determination and/or the generation of the assessment, or both, can be carried out using the machine learning agent.

In some examples, the determination can comprise requesting the generative machine learning model as to whether a particular assessment of the risk of cyber attacks on the system accurately reflects the results of carrying out one or more cyber attacks on the system.

Alternatively, the generation can comprise requesting the machine learning model to generate, according to a particular metric, an assessment of the risk of cyber attacks on the system according to the results of carrying out one or more cyber attacks on the system.

The assessment can be based on a metric for assessing the risk of cyber attacks on the system (e.g., a Threat and Risk Assessment—TARA metric). In some examples, the metric can comprise a global estimation of the risk of cyber attacks on the system (for example, on a particular scale). The metric can comprise one or more criteria to assess the risk of cyber attacks. In some examples, the criteria comprise one or more of attack/attacker sophistication or expertise, an assessment of the amount or complexity of the means used within the framework of the attack, an assessment of the time required for an attack (e.g., a successful attack), and/or the degree of access the attacker has to the system. Some examples of possible criteria are presented below.

The criterion of attack/attacker sophistication or expertise can be assessed in the techniques of the present disclosure by the machine learning agent carrying out attacks with different configurations and/or using different machine learning models for different attacks. Thus, a machine learning model retrained and/or configured using more extensive resources can simulate a more experienced attacker than a machine learning model retrained and/or configured without using the more extensive resources (or, e.g., a generative machine learning model that has not been retrained at all and/or configured for the specific tasks of the present disclosure, e.g., a large language model trained for multimodal speech generation).

The criterion of assessing the amount or complexity of the means used within the framework of the attack can be assessed in the techniques of the present disclosure by having the machine learning agent carry out attacks using various tools. For example, for an initial attack, the machine learning agent can only have access to one API of the system. For a further attack, the machine learning agent can have access to a diagnostic tool (e.g., a workshop).

The criterion for assessing the time required for an attack (e.g., for a successful attack) can comprise a time that is required for the attack to reach a predefined goal (be successful).

The criterion of a degree of access of the attacker to the system can be assessed in the techniques of the present disclosure by the machine learning agent gaining access to different interfaces or other components of the system for different attacks (e.g., for a first attack, access only to an over-the-air interface and for a second attack, access to a physical interface).

The criteria presented above (or other criteria) can be assessed on a particular scale. The machine learning agent can be designed (e.g., by appropriate training or configuration of the generative machine learning model, or by using a further machine learning model, or by using a non-machine learning module) to generate an assessment in response to the evaluation of the results of the cyber attacks. For example, carrying out a cyber attack via a first interface can successfully modify data in a memory and/or implant malware, whereas carrying out the attack via a second interface may not. This may lead to a particular risk assessment (e.g., a medium or high risk assessment).

In some examples, the method can further comprise receiving the predetermined assessment of the risk of cyber attacks on the system and adjusting the predetermined assessment of the risk of cyber attacks on the system if the determination indicates that the predetermined assessment of the risk of cyber attacks on the particular system is incorrect. The predetermined assessment can comprise a metric for assessing the risk of cyber attacks on the system (e.g., a Threat and Risk Assessment (TARA) metric) as described above. The comparison can comprise generating an assessment as described above and comparing the generated and predetermined assessments. If a deviation between the generated and the predetermined assessments is above a particular threshold value, a lack of correctness of the predetermined assessment can be determined. Subsequently, an adjustment of the predetermined assessment can be carried out. Alternatively or additionally, further steps can be taken (e.g., further tests for assessing the risk of cyber attacks on the particular system).

In the following, further aspects of the machine learning agent of the present disclosure are discussed with reference to FIG. 2. FIG. 2 schematically illustrates a structure of a machine learning agent 10 according to the present disclosure.

The machine learning agent 10 can comprise an interface 22 for receiving requests (as described above). The requests can be user requests. In some examples, the interface 22 can be a network interface (e.g., providing or containing an API or a web interface). In this way, in some examples, it may be possible to offer the techniques of the present disclosure as SaaS (software-as-a-service).

The machine learning agent 10 can comprise a core 24 that comprises a generative machine learning model 26. In addition, the machine learning agent 10 can comprise a planning module 28 and memory 30. Additionally or alternatively, the machine learning agent 10 can access and/or comprise one or more tools and/or data sets 32.

In some examples, the machine learning agent 10 can be further designed to access one or more tools or data sets 32 that are designed to ascertain information with respect to cyber attacks on the system and/or characteristics of the system.

Alternatively or additionally, the one or more tools or data sets 32 can contribute to generating or carrying out the cyber attacks. The one or more cyber attacks on the system can additionally be generated and carried out using the one or more tools or data sets.

For example, the machine learning agent can be designed to use information obtained by means of the one or more tools or data sets 32 to request the generative machine learning model 26. In some examples, the generative machine learning model 26 can be adjusted (e.g., through further learning and/or fine-tuning) to incorporate into the generated data sets information obtained by means of the one or more tools or data sets 32. For example, one of the one or more tools or data sets 32 can comprise a collection of descriptions of known types of attacks on the particular system (or portions thereof). In some examples, generating the one or more cyber attacks can comprise selecting known attack patterns from the collection and generating a cyber attack according to the known attack patterns. For example, there may be collections of attack types available for particular systems in different publications. The collections of attack types can be domain-specific in some examples. For example, in the automotive sector, there is the book “The car hacker's handbook: a guide for the penetration tester” by Craig Smith from 2016. This book presents cyber attacks on vehicles in detail.

The planning module 28 can be designed to identify, based on a request, one or more steps that must be carried out for responding to the request (and the order thereof). The planning module 28 can use the generative machine learning model 26 for this task. The planning module 28 can be designed to use one or more computer-based reasoning methods (e.g., chain-of-thoughts or tree-of-thoughts) for these tasks. The planning module 28 can receive feedback from the other modules while carrying out the methods of the present disclosure.

The memory 30 can be designed to internal logs of the machine learning agent 10, including past thoughts, actions, and observations from the environment, including all interactions between the machine learning agent 10 and a user.

The core 24 is designed to issue requests (prompts) to the generative machine learning model 26 based on the request and according to the steps specified by the planning module 28, in order to carry out the tasks of generating and carrying out the cyber attacks and optionally evaluating the results and/or generating and/or determining the correctness of the assessments. As part of this process, the core 24 can select or generate the requests (prompts) to the generative machine learning model 26. For example, the request (prompt) can comprise one or more of identifying a particular attack type or attack path for a cyber attack, developing a strategy for carrying out a particular attack type, providing tools (e.g., program code, commands on interfaces or tools or the like) for generating and carrying out the attacks, providing tools (e.g., program code, commands on interfaces or tools or the like) for evaluating the results of the attacks, assessing the risk of cyber attacks on the particular system (e.g., according to a predetermined metric), and/or determining whether a predetermined assessment of the risk of cyber attacks on the particular system is correct.

In a specific example, a sequence of requests from core 24 might look like this. Initially, the core 24 can send a request to the generative machine learning model 26 to identify an attack path. The generative machine learning model 26 can, in response, identify an interface (e.g., a CAN interface) as a possible attack path. In a further step, the core 24 can send a request to the generative machine learning model 26 to design a strategy for a cyber attack along this attack path. In response, the generative machine learning model 26 can propose randomly generating interface messages and feeding them to the interface. The core 24 can request the generative machine learning model 26 to write program code for generating the interface messages and for monitoring a memory of the particular system (e.g., an executable script or other programming code in a particular programming language). The agent 24 can execute the program code in a simulation environment of the particular system in order to carry out the selected attack. In other examples, the core 24 can request the generative machine learning model 26 to write the interface messages itself. In still other examples, the core 24 can request the generative machine learning model 26 to write commands to generate the interface messages. In a further step, the core 24 can execute the program code or commands for monitoring the memory. In one example, the core 24 can receive feedback that a memory of the particular system could be written to while carrying out a cyber attack (i.e., the evaluation indicates a successful attack). In response, the core 24 can send a request to the generative machine learning model 26 as to whether a predetermined assessment of the risk of cyber attacks on the particular system is correct. For example, the generative machine learning model 26 can respond that the successful attack indicates a higher risk assessment than a predetermined risk assessment. In some examples, the result (possibly with automatedly generated logs and/or explanations) can be output via an output interface of the machine learning agent 10.

The tools and/or data sets 32 can comprise any means that the machine learning agent 10 can use to (possibly automatedly) carry out the steps described herein. In some examples, the tools comprise interfaces to a test environment of the particular system. Additionally or alternatively, the tools and/or data sets 32 can be devices or systems in a test environment of the particular system. For example, the tools 32 can comprise interfaces and/or devices with which the machine learning agent 10 can intervene in a simulation environment of the particular system or in another test environment (e.g., a hardware-in-the-loop environment).

Further additionally or alternatively, the tools can be databases and/or other data structures that the machine learning agent 10 can access within the framework of carrying out the steps described herein. The databases and/or other data structures can contain, e.g., information regarding one or more of the following: a security concept for the particular system describing cyber attack defense measures implemented in the particular system, security requirements for the particular system or a class of systems comprising the particular system describing cyber attack defense measures to be implemented in the particular system, assessments (e.g., according to predetermined metrics) of the risk of cyber attacks on the particular system or similar systems, and/or historical data (e.g., logs) with respect to one or more of the foregoing. A query for data from the databases and/or other data structures can in turn be generated by the generative machine learning model 26. The information from the databases and/or other data structures can be used in various ways in the techniques of the present disclosure. For example, an attack path or attack type can be selected based on a security concept of the particular system or based on security requirements.

Techniques for training and/or configuring the machine learning agent 10 of the present disclosure are described below.

The present disclosure also relates to a method for training and/or configuring a machine learning agent 10 to determine correctness and/or to generate an of the risk of cyber attacks on a particular system. FIG. 1 schematically illustrates in the left column (I) a method for training and/or configuring a machine learning agent to determine correctness and/or to generate an of the risk of cyber attacks on a particular system.

The method comprises receiving 111 an initial generative machine learning model that is trained to generate data sets. The initial generative machine learning model can be trained to generate the data sets without being specifically adjusted or configured for the methods of the present disclosure. In some examples, the initial generative machine learning model is a generative foundation model (e.g., a language model, in particular a large language model, e.g., the specific models mentioned above). In other words, the initial generative machine learning model can be trained on training data that comprise the information described in the present disclosure (e.g., regarding cyber attacks or assessments of the risk of cyber attacks on systems). However, training data containing this information were not treated differently in the training of the initial generative machine learning model than training data that did not contain this information. In other words, the initial generative machine learning model is not a task-specific trained and/or configured generative machine learning model in relation to the tasks of the present disclosure.

The method further comprises configuring 113 a machine learning agent 10 to access the generative machine learning model that is trained to generate data sets and to generate and carry out one or more cyber attacks on a system based on a request using the generative machine learning model. In some examples, configuring the machine learning agent comprises designing the machine learning agent to access one or more tools and/or data sets 32 that are designed to ascertain information with respect to cyber attacks on the system and/or characteristics of the system and/or that contribute to carrying out the cyber attacks. The one or more cyber attacks on the system are additionally generated and carried out using the one or more tools and/or data sets 32. The tools and/or data sets 32 can contain one or more of the tools and/or data sets described above.

Configuring 113 can contain further training or fine-tuning of the initial generative machine learning model in order to generate a generative machine learning model that is designed for the tasks of the present disclosure (generating and carrying out the cyber attacks and optionally evaluating the results of the cyber attacks and/or determining and/or generating the assessment). Training or fine-tuning can be carried out using training data that contain historical or synthesized data regarding the respective tasks. In some examples, further training or fine-tuning of the initial generative machine learning model can comprise using a collection of descriptions of known attack types or attack paths against the particular system or a class of systems that comprises the particular system. For example, there may be domain-specific collections of attack types available for particular systems. The initial generative machine learning model can be further trained to generate attack types or attack paths from the collection.

In the course of further training or fine-tuning of the initial generative machine learning model, one or more items of information regarding one or more of the following: a security concept for the particular system describing measures to defend against cyber attacks implemented in the particular system, security requirements for the particular system or a class of systems comprising the particular system describing measures to defend against cyber attacks to be implemented in the particular system, assessments (e.g., according to predetermined metrics) of the risk of cyber attacks on the particular system or similar systems, and/or historical data (e.g., logs) with respect to one or more of the foregoing can further be used.

In the previous sections, measures for further training or fine-tuning an initial generative machine learning model were described. In other examples, the machine learning agent and the generative machine learning model contained therein can also be trained from scratch to carry out the tasks of the present disclosure.

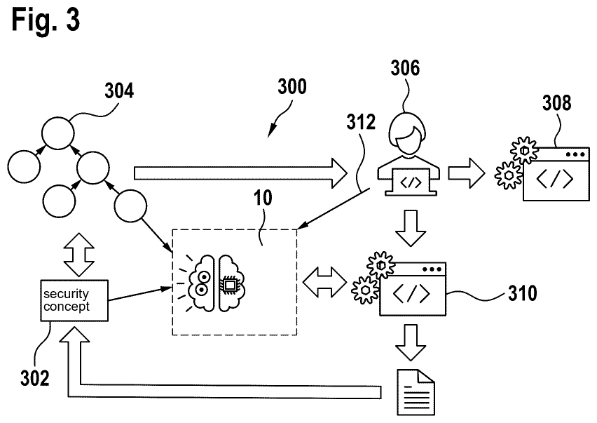

The following describes an embedding of the machine learning agent 10 in a test and/or development environment. FIG. 3 schematically illustrates a test and/or development environment 300 in which the machine learning agent 10 according to the present disclosure can be used.

In general, the methods of the present disclosure can be carried out within the framework of a development process of the particular system.

The present disclosure also relates to carrying out one of the techniques for determining correctness and/or for generating an assessment of the risk of cyber attacks on a particular system and implementing the particular system after carrying out the techniques for determining correctness and/or for generating an assessment of the risk of cyber attacks. Depending on the type of the particular system, the implementation can contain creating an instance of the particular system, installing software to create an instance of the particular system or similar implementation steps. Specific systems are described below.

As already mentioned, one of the techniques for determining correctness and/or for generating an assessment of the risk of cyber attacks can be carried out on models or prototypes of the particular system. In the present disclosure, therefore, the term “particular system” describes both these prototypes or models and later stages of development up to a marketable product. It is understood that both the shape and configuration of the particular system may change during this process (e.g., from a model in a simulation to a marketable control unit).

The methods of the present disclosure can be carried out at any stage of a product life cycle of a product containing the particular system. The methods of the present disclosure can, in some examples, be carried out iteratively (i.e., the methods are carried out multiple times in succession, e.g., an assessment of the risk of cyber attacks being modified at the end of each method being carried out).

One test and/or development environment 300 according to FIG. 3 shows, in addition to the machine learning agent 10, various other elements.

For example, a security concept 302 may be defined for the particular system. Additionally and alternatively, an assessment of the risk of cyber attacks on the particular system 304 may be defined. The latter can, in some examples, be generated and/or adjusted according to the techniques of the present disclosure. An initial assessment of the risk of cyber attacks on the particular system 304 can, in some examples, be generated in other ways (e.g., manually or via a further machine learning model).

Based on the security concept 302 and/or the assessment of the risk of cyber attacks on the particular system 304, a particular system 312 can be developed 306 for carrying out the techniques of the present disclosure. The particular system generated in this step can be a model or prototype or a model (e.g., a “minimal viable product-MVP”). The particular system thus generated can be assessed by the machine learning agent 10 by means of the techniques of the present disclosure. Alternatively or additionally, the particular system thus generated can be subjected to one or more steps of a verification and validation process 310 (which can result in the release 308 of the particular system for implementation). The results of the assessments of the present disclosure can be incorporated into the verification and validation methods. For example, a configuration and/or security concept for the particular system can be adjusted (e.g., if it arises that the particular system comprises certain vulnerabilities for cyber attacks, e.g., by implementing measures to close these vulnerabilities).

In some examples, the machine learning agent 10 can be designed to suggest or carry out modifications to the security concept and/or the particular system to close discovered vulnerabilities (e.g., by modifying a program code of the predetermined system).

The present disclosure also relates to an environment 300 that is designed to carry out one of the methods according to the present disclosure. In some examples, the environment can be a test and/or development environment for the particular system.

The present disclosure also relates to a method of using 121 a particular system according to the steps of the techniques of the present disclosure.

In examples, the particular system can be designed to control a technical system by means of closed-loop and/or open-loop control and/or monitor said system.

In examples, the method can comprise using the particular system to control by means of open-loop and closed loop control and/or monitor a vehicle function, a robot function, a building automation function, a power tool automation function, and/or a home appliance automation function.

In one example, the particular system can be designed to be arranged in a vehicle and/or be designed to control a vehicle function by means of open-loop control (in particular to control a driving function). For example, the vehicle function can be a function for autonomous and/or assisted driving. In some examples, the particular system can be designed to be executed on a computer system of a vehicle (for example, an autonomous, highly automated or assisted driving vehicle). For example, the computer system can be implemented locally in the vehicle or (at least partially) in a backend that is communicatively connected to the vehicle. For example, the particular system can comprise or be a control unit. In some examples, the vehicle can comprise a computer system with a communication interface which allows communication with a backend. For example, the particular system can be executed in this backend. In one example, the particular system can be a system for transverse guidance and/or longitudinal guidance of the vehicle. In examples, the particular system can receive velocity information or distance information as input data. Alternatively or additionally, the input data can comprise a relative velocity and/or a distance between a first vehicle, a second vehicle, a person and/or a stationary object. Alternatively or additionally, the input data can comprise variables based at least on one of a steering angle, an orientation angle, a yaw rate, a slip angle, and/or a lateral error. Alternatively or additionally, the input data can comprise information from a network, such as motion information and/or direction information from other vehicles. In examples, this information can be provided by means of vehicle-to-vehicle communication (V2V communication) or by means of a backend (V2X communication). Alternatively or additionally, the input data can comprise a steering velocity or target specifications for acceleration processes and/or braking processes.

In examples, the particular system can be designed to be arranged in a drive controller or a drive unit and/or can be used to control a motor-related function by means of closed-loop control (in particular for motor control). In examples, the particular system can be designed to be arranged in a drive controller of an electric machine. For example, the state vector of the state space model can contain variables based on at least one of a control signal, an operating mode or a power setting of the electric machine.

The present disclosure also relates to using the particular system to control a robot by means of closed-loop and/or open loop control and/or monitor said robot.

In other examples, the particular system can be arranged in a robot, and/or can be designed to control a robot function by means of open-loop control (in particular to control a motion function of a robot). For example, the particular system can be a system for transverse guidance and/or longitudinal guidance of the robot. In some examples, the particular system can be executed on a computer system of a robot. For example, the computer system can be locally implemented in the robot or (at least partially) in a backend that is communicatively connected to the robot. In some examples, the particular system can be executed in a backend. In examples, the particular system can receive velocity information or distance information as input data. Alternatively or additionally, the input data can comprise a relative velocity and/or a distance between a first robot, a person, a further mobile device and/or a stationary object. Alternatively or additionally, the input data can comprise variables based at least on one of a steering angle, an orientation angle, a yaw rate, a slip angle, and/or a lateral error. Alternatively or additionally, the input data can comprise information from a network, such as motion information and/or direction information from other robots, mobile devices and/or people. In examples, this information can be provided by means of direct communication or by means of a backend. In one example, an input vector can comprise a steering velocity or target specifications for acceleration processes and/or braking processes.

The present disclosure also relates to using the particular system to control functions in building automation by means of open-loop and/or closed-loop control and/or monitor said functions.

In one example, the particular system can be designed to be arranged in a building and/or to control building functions by means of open-loop and/or closed-loop control (in particular to control building automation functions by means of open-loop and/or closed loop control). For example, the building function can be a function for controlling room temperature, lighting, and/or safety equipment by means of closed-loop control.

The techniques of the present disclosure can, in some examples, be executed automatedly.

Furthermore, a computer system is disclosed which is designed to carry out the methods for determining correctness and/or for generating an assessment of the risk of cyber attacks on a particular system. Alternatively or additionally, the computer system can be designed to carry out the methods for training and/or configuring a machine learning agent to determine correctness and/or to generate an of the risk of cyber attacks on a particular system according to the present disclosure. The computer system can comprise a processor and/or a working memory. The computer system can be network-based and/or distributed.

Further disclosed is a computer program containing instructions that, if executed by a computer system, cause the computer system to carry out the method for determining correctness and/or for generating an assessment of the risk of cyber attacks on a particular system. Alternatively or additionally, the computer program can contain instructions that, if executed by a computer system, cause the computer system to carry out the methods for training and/or configuring a machine learning agent for determining correctness and/or for generating an of the risk of cyber attacks on a particular system according to the present disclosure. The computer program can be present, e.g., in interpretable or in compiled form. For execution, it can (even in portions) be loaded into the RAM of a computer, e.g., as a bit or byte sequence.

What is claimed is:

1. A method for determining correctness and/or for generating an assessment of a risk of cyber attacks on a particular system, the method comprising the following steps:
receiving a request to carry out one or more cyber attacks on the particular system;
invoking a machine learning agent, wherein the machine learning agent is configured to:
access a generative machine learning model that is trained to generate data sets, and
generate and carry out one or more cyber attacks on a system based on a request using the generative machine learning model;
carrying out one or more cyber attacks on the particular system using the machine learning agent in response to the request;
evaluating results of the one or more cyber attacks carried out; and
(i) determining, based on a finding of the step of evaluating the results, whether a predetermined assessment of the risk of cyber attacks on the particular system is correct or (ii) generating, based on a finding of the step of evaluating the results, an assessment of the risk of cyber attacks on the particular system.

2. The method according to claim 1, wherein:
the machine learning agent is further configured to access one or more tools or data sets that are configured to ascertain information with respect to cyber attacks on the system and/or characteristics of the system and/or that contribute to carrying out the cyber attacks, and
the one or more cyber attacks on the particular system are additionally generated and carried out using the one or more tools or data sets.

3. The method according to claim 2, wherein:
the machine learning agent is configured to use information obtained using the one or more tools or data sets to request the generative machine learning model, and/or
the generative machine learning model is adjusted to incorporate into the generated data sets information obtained using the one or more tools or data sets.

4. The method according to claim 2, wherein one of the one or more tools or data sets include a collection of descriptions of known attack patterns on the system.

5. The method according to claim 4, wherein generating the one or more cyber attacks includes selecting known attack patterns from the collection and generating a cyber attack according to the known attack patterns.

6. The method according to claim 1, wherein the data sets generated by the generative machine learning model include text data and/or image data.

7. The method according to claim 1, wherein:
the data sets generated by the generative machine learning model include calls to commands in a programming language and/or database queries,
carrying out one or more cyber attacks on the particular system includes calling commands in a programming language and/or database queries.

8. The method according to claim 1, further comprising:
receiving the predetermined assessment of the risk of cyber attacks on the particular system; and
adjusting the predetermined assessment of the risk of cyber attacks on the particular system when the determination indicates that the predetermined assessment of the risk of cyber attacks on the particular system is incorrect.

9. The method according to claim 1, wherein:
the machine learning agent is further configured to:
(i) carry out the evaluation of a result, and/or (ii) determine and/or generate the assessment, and
evaluating: (i) a result, and/or (ii) determining and/or generating the assessment, are carried out using the machine learning agent.

10. The method according to claim 9, wherein the determination includes requesting the generative machine learning model as to whether a particular assessment of the risk of cyber attacks on the system accurately reflects the results of carrying out one or more cyber attacks on the particular system.

11. The method according to claim 1, wherein the cyber attacks are carried out on a prototype of the particular system or a model of the particular system.

12. A method for training and/or configuring a machine learning agent to determine correctness and/or to generate an assessment of a risk of cyber attacks on a particular system, the method comprising the following steps:
receiving a generative machine learning model that is trained to generate data sets;
configuring a machine learning agent to:
access the generative machine learning model that is trained to generate data sets, and
generate and carry out one or more cyber attacks on a system based on a request using the generative machine learning model.

13. The method for training and/or configuring according to claim 12, wherein configuring the machine learning agent includes the following:
configuring the machine learning agent to access one or more tools or data sets that are configured to ascertain information with respect to cyber attacks on the system and/or characteristics of the system and/or that contribute to generating or carrying out the cyber attacks,
wherein the one or more cyber attacks on the system are additionally generated and carried out using the one or more tools or data sets.

14. An environment configured to determine correctness and/or to generate an assessment of a risk of cyber attacks on a particular system, including:
receiving a request to carry out one or more cyber attacks on the particular system;
invoking a machine learning agent, wherein the machine learning agent is configured to:
access a generative machine learning model that is trained to generate data sets, and
generate and carry out one or more cyber attacks on a system based on a request using the generative machine learning model;
carrying out one or more cyber attacks on the particular system using the machine learning agent in response to the request;
evaluating results of the one or more cyber attacks carried out; and
(i) determining, based on a finding of the step of evaluating the results, whether a predetermined assessment of the risk of cyber attacks on the particular system is correct or (ii) generating, based on a finding of the step of evaluating the results, an assessment of the risk of cyber attacks on the particular system.

15. The environment according to claim 14, wherein the environment is a test and/or development environment for the particular system.

16. A non-transitory computer-readable medium on which is stored a computer program that contains instructions for determining correctness and/or for generating an assessment of a risk of cyber attacks on a particular system, the instructions, when executed by a computer, causing the computer to perform the following steps:
receiving a request to carry out one or more cyber attacks on the particular system;
invoking a machine learning agent, wherein the machine learning agent is configured to:
access a generative machine learning model that is trained to generate data sets, and
generate and carry out one or more cyber attacks on a system based on a request using the generative machine learning model;
carrying out one or more cyber attacks on the particular system using the machine learning agent in response to the request;
evaluating results of the one or more cyber attacks carried out; and
(i) determining, based on a finding of the step of evaluating the results, whether a predetermined assessment of the risk of cyber attacks on the particular system is correct or (ii) generating, based on a finding of the step of evaluating the results, an assessment of the risk of cyber attacks on the particular system.
